(19) United States
(12) Patent Application Publication
(10) Pub. No.: US 2018/0313603 A1
(43) Pub. Date: Nov. 1, 2018

(54) APPARATUS AND METHOD FOR PRODUCING LIQUEFIED GAS

(71) Applicant: L'Air Liquide, Société Anonyme pour I'Etude et I'Exploitation des Procédés Georges Claude, Paris (FR)

(72) Inventors: Daisuke NAGATA, Kobe (JP); Shinji TOMITA, Kobe (JP)

(21) Appl. No.: 15/771,731

(22) PCT Filed: Oct. 28, 2015
(86) PCT No.: PCT/EP2015/074953

§ 371 Date: Apr. 27, 2018

(51) Int. Cl. F25J 1/00; F25J 1/02

(52) U.S. Cl. CPC F25J 1/0015; F25J 2230/42; F25J 1/0224; F25J 1/0265; F25J 1/0281; F25J 1/0292; F17C 2221/033; F17C 2223/0161; F17C 2223/035; F17C 2225/0123; F17C 2227/0316; F17C 2227/0323; F17C 2227/0393; F17C 2265/05; F17C 2270/0136; F25J 2210/62; F25J 2230/20; F25J 2230/30; F25J 1/0222

(57) ABSTRACT

An apparatus for producing a liquefied gas using a Rankine cycle is provided. The apparatus includes a first compression means for adiabatically compressing a heat transfer medium; a first heat exchanger for constant pressure heating the adiabatically compressed heat transfer medium; a plurality of parallelly arranged expansion means for adiabatically expanding the heated heat transfer medium; a second heat exchanger for constant pressure cooling the adiabatically expanded heat transfer medium; and a flow passageway for guiding the heat transfer medium that has been guided out from the second heat exchanger to the first compression means.

### CROSS REFERENCE TO RELATED APPLICATIONS

This application is a 371 of International PCT Application PCT/EP2015/074953 filed Oct. 28, 2015, the entire contents of which are incorporated herein by reference.

### FIELD OF THE INVENTION

The present invention relates to an apparatus and a method for producing a liquefied gas using the coldness of a liquefied natural gas (hereafter also referred to as “LNG”), and is particularly useful as a technique for liquefying nitrogen gas that is produced by an air separation apparatus or the like.

### BACKGROUND

Natural gas (NG) is stored as a liquefied natural gas (LNG) for facility in transportation and storage, or the like, and is used mainly for thermal power generation or for city gas after being vaporized. For this reason, a technique of effectively utilizing the coldness of LNG is developed.

Generally, as equipment for liquefying nitrogen gas or the like by using the coldness of LNG, a process is used such that nitrogen gas is compressed by a compressor up to a pressure such that the nitrogen gas can be liquefied by heat exchange with the LNG, and subsequently the nitrogen gas is subjected to the heat exchange with the LNG in a heat exchanger to vaporize the LNG by raising the temperature and to liquefy the nitrogen gas.

Also, with respect to the electric power for driving the compressor, the fee for night time is set to be lower than the fee for daytime, so that a gas liquefying process for efficiently liquefying a gas while taking the fluctuation of the supply amount of the above LNG and the difference in the electric power fee into consideration is proposed.

For example, with reference to FIG. 8, there is known a method of liquefying a gas by using the coldness of liquefied natural gas by a liquefaction process provided with at least one gas compressor 101, at least one gas expansion turbine 103, and a heat exchanger 102 for performing heat exchange between the gas and the liquefied natural gas, in which the expansion turbine 103 is stopped or operated in a decreased amount when the supplied liquefied natural gas increases in amount, while the expansion turbine 103 is started or operated in an increased amount when the supplied liquefied natural gas decreases in amount (see, for example, JP-A-05-45050).

Also, generally in such a liquefaction process, a compander in which a booster is coupled to a shaft of an expansion turbine is widely used.

By compressing a low-pressure fluid into a high-pressure fluid by the booster and guiding the high-pressure fluid into the expansion turbine and expanding, it can be made into a low-temperature fluid.

At this time, the work generated by the expansion is collected by a booster compressor coupled to the shaft of the expansion turbine (see, for example, JP-A-10-501053). Also, in the case of using a compander in which a booster is coupled to a shaft of an expansion turbine in a liquefaction process, there is known a method of performing two stages of pressure raising by a blower and expanding and temperature lowering by the expansion turbine (see, for example, JP-A-09-049685 and JP-A-06-050657).

However, with an apparatus for producing a low-temperature liquefied gas or the like such as described above, various problems such as the following occurred in some cases.

(i) The amount of LNG supplied to the gas liquefying process may generally fluctuate due to the fluctuation in the demand for thermal power generation, city gas, or the like, and the amount of coldness that can be used may also fluctuate. Therefore, there is a demand for an apparatus or a method by which the coldness of LNG can be efficiently used so that the amount of production of the liquefied gas or the like may not be affected even when the supplied LNG decreases in amount.

(ii) In order to pressurize a gas having a normal temperature and a normal pressure in a process for producing a compressed gas, addition of a large amount of energy and the coldness for restraining the gas temperature rise accompanying the compression are needed. In producing a compressed gas for general use that is consumed in a large amount, such as a nitrogen gas, there is a big problem for an efficient use of the coldness and comprehensive reduction of energy.

(iii) With respect to the temperature at which a gas having a normal pressure starts being liquefied, the temperature is about −80° C. for LNG, while the temperature is about −120° C. for nitrogen. For example, in a process for liquefying nitrogen gas at a normal pressure using LNG as the coldness, in a state in which the liquefaction of nitrogen has started, the LNG that is subjected to heat exchange with this nitrogen is still in a liquid state having a large latent heat, so that, in view of this process alone, it cannot be said that the coldness of the LNG is sufficiently used. Also, it is not necessarily easy to use the coldness of the remaining LNG for other purposes, so that there is a big problem for an efficient use of energy including the coldness of LNG in such a liquefaction process.

(iv) Also, there has been a problem in that, with respect to the booster coupled to the expansion turbine, it is extremely difficult to make the compression ratio be about 2.5 times or more due to mechanical restriction. Further, even by the method of performing two stages of pressure raising by the blower and expansion and temperature lowering by the expansion turbine as described above, it has not been possible to make the compression ratio be about 2.5 times or more.

(v) Generally, in order to obtain a predetermined pressure by a high compression ratio, a method is adopted in which multiple stages of compressor units are provided and, after the pressure of a fluid is raised to a predetermined pressure in advance, the pressure is raised to a desired pressure by the booster of the compander. However, for example, in a liquefied nitrogen production process, the energy consumed by operation of the multiple stages of compressor units is almost all of the energy needed in an expansion cycle thereof, so that this has been a great obstacle from the viewpoint of reducing energy consumption or improving the energy efficiency, or the like.

### SUMMARY OF THE INVENTION

An object of the present invention is to provide an apparatus and a method for producing a liquefied gas that can reduce the energy that is needed in preparing the liquefied gas by efficiently using the coldness of LNG and can ensure a large compression ratio or a compression ratio having a large degree of freedom by effectively using an expansion turbine without using a member consuming a large amount of energy such as a compressor unit.

The present inventors have made eager studies in order to solve the above problems and, as a result, have found that the above object can be achieved by an apparatus and a method for producing a liquefied gas described below, thereby completing the present invention.

An apparatus for producing a liquefied gas according to the present invention using a Rankine cycle system comprises; a first compression means for adiabatically compressing a heat transfer medium; a first heat exchanger for constant pressure heating the adiabatically compressed heat transfer medium; a plurality of parallelly arranged expansion means for adiabatically expanding the heated heat transfer medium; a second heat exchanger for constant pressure cooling the adiabatically expanded heat transfer medium; and a flow passageway for guiding the heat transfer medium that has been guided out from the second heat exchanger to the first compression means, wherein a plurality of serially arranged second compression means, the number of which is the same as that of the expansion means, that are coupled to the expansion means, wherein a liquefied natural gas in a low-temperature liquefied state is guided into the second heat exchanger and guided out after transferring the coldness thereof to the heat transfer medium, and a source material gas that has been fed is sequentially compressed by the plurality of the second compression means and thereafter guided into the first heat exchanger or the second heat exchanger to be cooled by the heat transfer medium, so as to be taken out as a liquefied gas.

Further, a method for producing a liquefied gas according to the present invention comprises a Rankine cycle system in which a heat transfer medium that has been adiabatically compressed by first compression means is heated in a first heat exchanger at a constant pressure, thereafter adiabatically expanded by a plurality of parallelly arranged expansion means, and further cooled in a second heat exchanger at a constant pressure, wherein a liquefied natural gas in a low-temperature liquefied state is guided into the second heat exchanger to transfer the coldness thereof to the heat transfer medium, and a source material gas that has been fed is sequentially compressed by a plurality of serially arranged second compression means, the number of which is the same as that of the expansion means, that are coupled to the expansion means, and thereafter guided into the first heat exchanger or the second heat exchanger to be cooled by the heat transfer medium, so as to be taken out as a liquefied gas.

Such a structure allows that, in preparing a liquefied gas, there can be provided an apparatus and a method for producing a liquefied gas that can reduce the energy that is needed in preparing the liquefied gas by efficiently using the coldness of LNG and can ensure a large compression ratio or a compression ratio having a large degree of freedom by effectively using an expansion turbine without using a unit consuming a large amount of energy such as an independent compressor. Specifically, based on a knowledge that the heat transfer is efficiently carried out by heat exchange with a compressed gas and the coldness needed in preparing a liquefied gas is extremely small, by applying a Rankine cycle system (hereafter also referred to as “RC”) that can effectively use the heat exchange with a compressed gas in preparing a low-temperature gas, the coldness of LNG can be used much more efficiently, and the energy needed in transferring the coldness can be reduced to a great extent. Also, by using the plurality of parallelly arranged expansion turbines used in the RC, and sequentially serially compressing the source material gas using the same number of second compression means that are coupled to the expanders, a large compression ratio or a compression ratio having a large degree of freedom can be ensured.

As will be described later, the term “second compression means” as used herein refers to a compressor or the like coupled to a turbine, as distinguished from a unit having an independent compression function such as a compressor unit.

The present invention relates also to the apparatus for producing the liquefied gas described above, comprising a flow passageway for guiding the source material gas guided out from the second compression means to the first heat exchanger or the second heat exchanger, an adjustment valve for adjusting the pressure of the liquefied gas that has been guided out from the first heat exchanger or the second heat exchanger, and a gas-liquid separation section into which the liquefied gas is guided via the adjustment valve so as to be subjected to gas-liquid separation into a liquid component and a gas component, wherein the gas component that has been guided out from the gas-liquid separation section is guided into the second compression means, and the liquid component is taken out as a liquefied gas.

The present invention relates also to the method for producing the liquefied gas described above, wherein the source material gas guided out from the second compression means is cooled in the first heat exchanger or the second heat exchanger, subjected to pressure adjustment by an adjustment valve, and subjected to gas-liquid separation into a liquid component and a gas component in a gas-liquid separation section, whereafter the gas component guided out from the gas-liquid separation section is guided into the second compression means, and the liquid component is taken out as a liquefied gas.

When the coldness of LNG is used in preparing a liquefied gas such as nitrogen gas, the temperature of the LNG is around −155° C. while the boiling point of nitrogen under atmospheric pressure is −196° C., so that this difference in temperature levels between these must be compensated between these. The present invention realizes such a function with use of a Rankine cycle system. The heat transfer medium used in the Rankine cycle system is cooled to about −150 to −155° C. by using the coldness of LNG to ensure the coldness to be transferred to nitrogen gas or the like. After the pressure is raised typically to a critical pressure or above (for example, 5 to 6 MPa), the coldness is transferred through the first heat exchanger to the nitrogen gas or the like in a normal pressure or in a low-pressurized condition, and further the coldness is transferred through the second heat exchanger to the nitrogen gas or the like compressed to a high pressure, whereby a liquefied nitrogen gas can be efficiently prepared. In preparing a liquefied gas, the coldness of the LNG can be used more efficiently, and the energy needed in transferring the coldness can be reduced to a great extent.

The present invention relates also to the apparatus for producing a liquefied gas described above, wherein a third heat exchanger is disposed in a flow passageway through which the heat transfer medium that has been guided out from the first heat exchanger is guided to the expansion means, and in the third heat exchanger, the heat transfer medium, the liquefied natural gas that has been guided out from the second heat exchanger, and the source material gas that has been guided out from the second compression means undergo heat exchange.

With such a structure, the coldness of the LNG can be used further more efficiently, and preparation of a liquefied gas having a high energy efficiency can be carried out.

In particular, when cooling water is introduced in the third heat exchanger to perform heat exchange by cold energy having a large heat capacity, transfer of preparatory or auxiliary hot heat to the heat transfer medium, the liquefied natural gas, and the liquefied gas can be carried out even to transient fluctuation or the like at the time of starting or at the time of stopping, thereby ensuring a stable use of the coldness of LNG and a stable energy efficiency.

The present invention relates also to the apparatus for producing a liquefied gas described above, wherein a first branching flow passageway and a second branching flow passageway are disposed in a flow passageway through which the source material gas is guided to the second compression means; a fourth heat exchanger and a third branching flow passageway are disposed in a flow passageway through which the liquid component that has been guided out from the gas-liquid separation section is guided; the apparatus has a flow passageway through which the gas component that has been guided out from the gas-liquid separation section is guided to the first branching flow passageway via the first heat exchanger or the second heat exchanger, and has a flow passageway through which the liquid component that has been branched by the third branching flow passageway is guided to the second branching flow passageway via the fourth heat exchanger, where the liquid component that has been guided out from the gas-liquid separation section is taken out as a liquefied gas via the fourth heat exchanger.

By constructing a circulation system in which the liquefied gas under stable conditions immediately before being taken out is mixed with the source material gas, it has been made possible to supply a liquefied gas stably and with a good energy efficiency.

The present invention relates also to the apparatus for producing a liquefied gas described above, wherein the Rankine cycle system is comprised with a plurality of Rankine cycle systems using a plurality of heat transfer media having different boiling points or heat capacities and has at least a plurality of parallelly arranged first expansion means according to one Rankine cycle system using a heat transfer medium having a low boiling point or a small heat capacity and a plurality of parallelly arranged second expansion means according to another Rankine cycle system using a heat transfer medium having a high boiling point or a large heat capacity; a plurality of serially arranged second compression means, the number of which is the same as that of the first expansion means, that are coupled to the first expansion means and a plurality of serially arranged third compression means, the number of which is the same as that of the second expansion means, that are coupled to the second expansion means are provided; wherein the source material gas, after being compressed by the second compression means, is further compressed by the third compression means to be guided into the first heat exchanger, or the source material gas, after being compressed by the second compression means, is further compressed by compression means of an initial stage of the third compression means to be guided into the first heat exchanger, and the liquefied gas that has been guided out is compressed by compression means of a next stage to be guided into the first heat exchanger, and this is repeated for a predetermined number of stages.

In many cases, an apparatus for producing a liquefied gas is used in line in semiconductor production equipment or the like, so that a continuous supply of gas is demanded, and also the amount of supply, the pressure of supply, and the like thereof may largely fluctuate.

Also, as described before, there are cases in which the stable supply of LNG is not necessarily ensured.

The present invention has made it possible to supply a liquefied gas stably and with a good energy efficiency by constructing with a plurality of Rankine cycle systems using a plurality of heat transfer media having different boiling points or heat capacities for the heat transfer medium that carries out the transfer of the coldness of LNG and adjusting the control elements that can be easily controlled, such as the flow rate and the pressure of the heat transfer medium, in each Rankine cycle system with regard to the fluctuating elements in these cases by adopting a structure in which the source material gas, after being compressed in multiple stages by the second compression means according to the first RC, is further compressed by compression means of the initial stage of the third compression means according to the second RC to be guided into the first heat exchanger or the second heat exchanger, and the liquefied gas that has been guided out is compressed by compression means of the next stage to be guided into the first heat exchanger or the second heat exchanger, and this is repeated for a predetermined number of stages.

### BRIEF DESCRIPTION OF THE DRAWINGS

For a further understanding of the nature and objects for the present invention, reference should be made to the following detailed description, taken in conjunction with the accompanying drawings, in which like elements are given the same or analogous reference numbers and wherein:

FIG. 1 is a schematic view illustrating a basic exemplary structure of an apparatus for producing a liquefied gas according to the present invention;

FIG. 2 is a schematic view exemplifying one mode of the first exemplary structure of an apparatus for producing a liquefied gas according to the present invention;

FIG. 3 is a schematic view illustrating the second exemplary structure of an apparatus for producing a liquefied gas according to the present invention;

FIG. 4 is a schematic view exemplifying one mode of the second exemplary structure of an apparatus for producing a liquefied gas according to the present invention;

FIG. 5 is a schematic view illustrating the third exemplary structure of an apparatus for producing a liquefied gas according to the present invention;

FIG. 6 is a schematic view illustrating the fourth exemplary structure of an apparatus for producing a liquefied gas according to the present invention;

FIG. 7 is a schematic view illustrating the fifth exemplary structure of an apparatus for producing a liquefied gas according to the present invention; and

FIG. 8 is a schematic view illustrating an exemplary structure of a gas liquefying process according to a conventional art.

### DETAILED DESCRIPTION OF THE PREFERRED EMBODIMENTS

### Structure of an Apparatus for Producing a Liquefied Gas

An apparatus for producing a liquefied gas according to the present invention (hereafter referred to as “present apparatus”) comprises a Rankine cycle system (RC) having first compression means for adiabatically compressing a heat transfer medium, a first heat exchanger for heating the adiabatically compressed heat transfer medium at a constant pressure, a plurality of parallelly arranged expansion means for adiabatically expanding the heated heat transfer medium, a second heat exchanger for cooling the adiabatically expanded heat transfer medium at a constant pressure, and a flow passageway for guiding the heat transfer medium that has been guided out from the second heat exchanger to the first compression means, and comprises a plurality of serially arranged second compression means, the number of which is the same as that of the expansion means, that are coupled to the expansion means, wherein a liquefied natural gas (LNG) in a low-temperature liquefied state is guided into the second heat exchanger and guided out (V.NG) after transferring the coldness thereof to the heat transfer medium, and a source material gas that has been fed is sequentially compressed by the plurality of the second compression means and thereafter guided into the first heat exchanger or the second heat exchanger to be cooled by the heat transfer medium, so as to be taken out as a liquefied gas. Hereafter, the embodiments of the present invention will be described with reference to the attached drawings. Here, in the present embodiments, cases in which nitrogen gas is the gas to be liquefied may be exemplified; however, the present invention can also be applied similarly to liquefaction of other gases, for example, air, argon, and the like. Further, conditions such as the temperature, the pressure, and the flow rate of each section can be suitably changed in accordance with other conditions such as the type of the gas and the flow rate, or the like.

### Basic Structure Example of the Present Apparatus

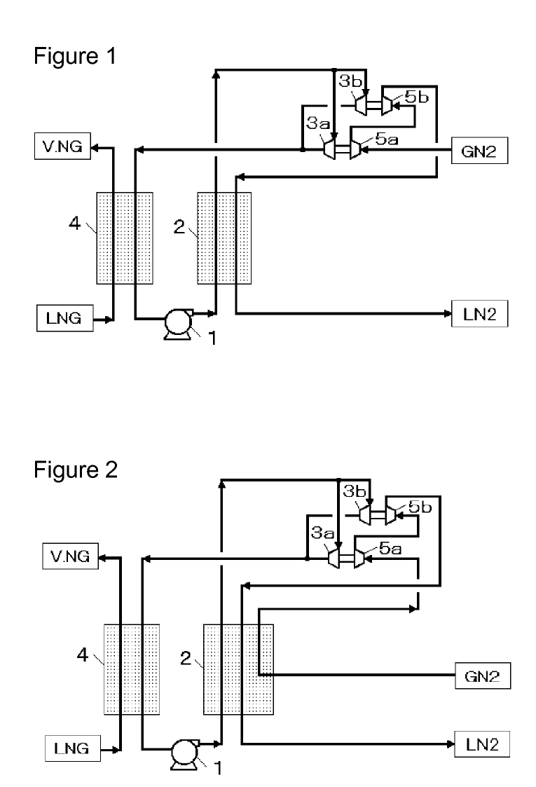

A basic structure example (first structure example) of the present apparatus will be schematically exemplified in FIG. 1. The present apparatus has a Rankine cycle system (RC) in which a heat transfer medium circulates. The heat transfer medium forms a circulation system in which, sequentially, the heat transfer medium is adiabatically compressed by a compression pump 1 which is first compression means, cooled at a constant pressure by a source material gas in a first heat exchanger 2, adiabatically expanded by turbines 3a, 3b which are a plurality (two is exemplified in the present structure) of parallelly arranged expansion means, cooled at a constant pressure by the coldness of LNG in a second heat exchanger 4, and sucked again by the compression pump 1. By such a structure, the coldness of LNG can be stably and efficiently transferred to the source material gas. Here, the “heat transfer medium” may be selected from among various substances such as hydrocarbon, liquefied ammonia, liquefied chlorine, and water.

Also, at a normal temperature and under a normal pressure, the heat transfer media may include not only liquids but also gases, so that a gas having a large heat capacity, such as carbon dioxide, can be applied. Besides the case in which methane, ethane, propane, butane, or the like is used singly as the hydrocarbon, the optimum boiling point or heat capacity can be designed by using a mixture of a plurality of compounds.

In particular, when a plurality of RCs are used as will be described later, the cold energy of LNG can be thermally transferred in a plurality of temperature bands by using, for example, a mixture of “methane+ethane+propane” in one RC and using a mixture of “ethane+propane+butane” in another RC.

The LNG of a predetermined flow rate is supplied to the second heat exchanger 4, whereby a predetermined amount of coldness is ensured. By controlling the supply flow rate of the LNG, the amount of heat that is transferred to the heat transfer medium circulating in the RC can be controlled, and the coldness that is transferred to the source material gas can be easily adjusted. The LNG guided into the second heat exchanger 4 is partially or wholly vaporized and guided out as a vaporized natural gas (V.NG). A source material gas (GN2) of a desired flow rate is compressed by a compressor 5a which is a first stage of the second compression means, further compressed by a compressor 5b which is a second stage, thereafter supplied to the first heat exchanger 2 to be cooled to a desired temperature by receiving transfer of a predetermined amount of coldness, and compressed to a desired pressure to be taken out as a liquefied gas (LN2).

By such a structure, a desired liquefied gas can be produced stably while ensuring a desired high compression ratio.

Further, the energy efficiency can be improved to a great extent as compared with a conventional apparatus in which the coldness of LNG and the source material gas are subjected to direct heat exchange. Here, in each of the heat exchangers including the first to fourth heat exchangers exemplified in the present structure and the following structure examples, the LNG and the heat transfer medium, the source material gas, the liquefied gas, or the cooling water are guided in and supplied out suitably under countercurrent conditions or under cocurrent conditions. At this time, by setting the countercurrent conditions between the LNG and the heat transfer medium or the liquefied gas in the second heat exchanger 4 or between the heat transfer medium and the source material gas or the liquefied gas in the first heat exchanger 2, a particularly high heat exchange efficiency can be obtained.

As described above, in the present apparatus in which the Rankine cycle system (RC) has been comprised, a liquefied natural gas in a low-temperature liquefied state is guided into the second heat exchanger 4 to transfer the coldness thereof to the heat transfer medium, and the source material gas compressed by the compressors 5a, 5b coupled to the turbines 3a, 3b is guided into the first heat exchanger 2 to be cooled by the coldness of the heat transfer medium, so as to be taken out as a liquefied gas.

Specifically, an example will be given in which a mixture obtained by blending ethane and propane in an equal molar ratio as a major component, for example, is used as the heat transfer medium of the RC; LNG of about 6 MPa is guided into the second heat exchanger 4; and nitrogen gas is fed as a source material gas. In the example, the heat transfer medium guided out from the second heat exchanger 4 after being cooled to about −115° C. is adiabatically compressed to about 1.8 MPa by the compression pump 1, guided into the first heat exchanger 2, guided out after being heated by heat exchange with the source material gas, adiabatically expanded by the turbines 3a, 3b, and guided at about −45° C. and under about 0.05 MPa into the second heat exchanger 4.

The nitrogen gas (source material gas) guided into the first heat exchanger 2 after being sequentially compressed to about 2.1 MPa and to about 5 MPa by the compressors 5a, 5b coupled to the turbines 3a, 3b is guided out after being cooled to about −90° C. and taken out as a liquefied nitrogen gas having a temperature of about −90° C. and a pressure of about 5 MPa.

### With Regard to the Verification Result

A case in which a liquefied nitrogen gas was prepared using the present apparatus was compared with a case in which a liquefied nitrogen gas was prepared using a conventional method, so as to verify the energy efficiency thereof. As will be described below, an improvement of about 50% or more could be achieved by using the present apparatus.

(i) A case in which a liquefied nitrogen gas was prepared using a conventional method

Assuming that LNG is supplied at 1 ton/h and a compressor is operated at an electric power of 15.7 kWh, a nitrogen gas of 677 Nm³/h, for example, can be pressurized from 20 bar to 37 bar. During this time, the entrance temperature of the compressor is 40° C., and the exit temperature thereof is 111° C.

(ii) A case in which a liquefied nitrogen gas was prepared using the present method

The amount of LNG needed to obtain a similar liquefied nitrogen gas, that is, to pressurize a nitrogen gas of 677 Nm³/h from 20 bar to 37 bar, was 0.485 ton/h.

(iii) When the two cases are compared, it has been found out that the electric power could be reduced by about 8 kWh, that is, by about 52%, from the following formula 1.

(1−0.485)×15.7=8.09 [kWh]

8.09/15.7=0.52 (formula 1)

Furthermore, as one mode in the above-described basic structure example, a structure in which the source material gas is guided into the first heat exchanger 2 to lower the temperature thereof before being compressed will be exemplified in FIG. 2.

By such a structure, the cooling effect after adiabatic compression can be enhanced, and the liquefaction effect in the second heat exchanger 4 can be enhanced. Specifically, the source material gas guided into the first heat exchanger 2 is cooled to about −80° C. and guided out, then sequentially compressed to about 2.1 MPa and to about 5 MPa by the compressors 5a, 5b coupled to the turbines 3a, 3b, further guided into the first heat exchanger 2 to be cooled to about −90° C., and guided out so as to be taken out as a liquefied nitrogen gas having a temperature of about −90° C. and a pressure of about 5 MPa.

### Second Structure Example of the Present Apparatus

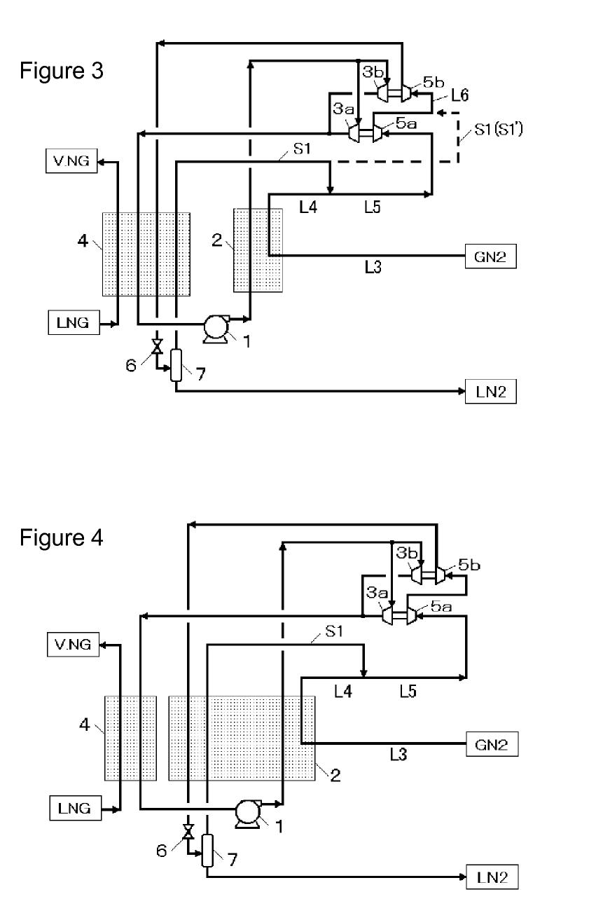

A second structure example of the present apparatus will be schematically shown in FIG. 3. Hereafter, elements common to those of the basic structure will be denoted with common nominations and reference symbols, and a description thereof may be omitted. The present apparatus has a similar Rankine cycle system (RC) and comprises a flow passageway through which the liquefied gas guided out from the compressors 5a, 5b is guided to the first heat exchanger 2 or the second heat exchanger 4 (guided into the second heat exchanger 4 in the second structure example), an adjustment valve 6 for adjusting the pressure of the liquefied gas guided out from the first heat exchanger 2 or the second heat exchanger 4 (guided out from the second heat exchanger 4 in the second structure example) and containing a liquid component, and a gas-liquid separation section 7 into which the liquefied gas is guided via the adjustment valve 6 so as to perform gas-liquid separation of the liquid component, wherein a gas component that has been guided out from the gas-liquid separation section 7 is guided into the compressor 5a, and the low-temperature liquid component is taken out as a liquefied gas (LN2).

Further, by guiding the source material gas (GN2) into the first heat exchanger 2 to lower the temperature thereof before compression, the cooling effect after adiabatic compression can be enhanced, and the liquefaction effect in the second heat exchanger 4 can be enhanced.

In addition to the functions in the basic structure, the difficulty of heat transfer due to the difference between the temperature of the supplied LNG and the boiling point of the source material gas can be eliminated by effectively using the RC and the gas-liquid separation section 7, whereby the coldness of the LNG can be efficiently used, and the liquefied gas can be prepared stably and efficiently.

Furthermore, in the second structure example, the gas component guided out from the gas-liquid separation section 7 may be guided into the second heat exchanger 4 to lower the temperature thereof and may be mixed via a flow passageway S1 with the source material gas fed via flow passageways L3 and L4, so as to be guided into the compressor 5a via a flow passageway L5, whereby the cooling effect can be further enhanced, and the liquefaction effect in the second heat exchanger 4 can be enhanced.

Further, by using the pressure that the gas component guided out from the gas-liquid separation section 7 has, the gas component may be mixed via a flow passageway S1 (S1′) shown by a broken line with the source material gas compressed by the compressor 5a in a flow passageway L6, and thereafter compressed by the compressor 5b, whereby the cooling effect after adiabatic compression can be further enhanced, and the liquefaction effect in the second heat exchanger 4 can be enhanced.

Such a structure allows that the supplied source material gas, in a state in which the pressure thereof is sequentially raised by the compressors 5a, 5b, is cooled in the second heat exchanger 4 and is subjected to pressure adjustment by the adjustment valve 6, and the condensed liquid component is subjected to gas-liquid separation in the gas-liquid separation section 7 and taken out as a low-temperature liquefied gas from the gas-liquid separation section 7.

At this time, when the source material gas is, for example, ethane or propane having a comparatively higher boiling point than nitrogen or oxygen, the source material gas can be liquefied also by being guided into the first heat exchanger 2 after the pressure thereof is raised by the compressors 5a, 5b, as exemplified in FIG. 4.

This is because the temperature difference from the coldness of the LNG is small, and the coldness of the LNG sufficient for liquefaction can be transferred via the heat transfer medium when the source material gas is guided out from the first heat exchanger 2 and again guided into the first heat exchanger 2 in a compressed state. Here, in the structure exemplified in FIG. 4 also, the structure shown by the broken line in FIG. 3 can be applied. Furthermore, in the case of [the pressure of the LNG]>[the pressure of the source material gas (for example, about 50 bar)], there is a possibility that the LNG may leak to the source material gas side, so that the risk thereof can be evaded with such a structure.

In the same manner as in the basic structure, a specific example will be given in which a mixture obtained by blending ethane and propane in an equal molar ratio as a major component, for example, is used as the heat transfer medium of the RC; LNG of about 6 MPa is guided into the second heat exchanger 4; and nitrogen gas is fed as a source material gas.

A source material gas guided into the first heat exchanger 2 is sequentially compressed to about 2.1 MPa and to about 5 MPa by the compressors 5a, 5b to become a low-temperature compressed nitrogen gas of about −50° C. This low-temperature compressed nitrogen gas is further guided into the second heat exchanger 4 to be cooled to about −153° C. and then is expanded via the adjustment valve 6 to be cooled to about −179° C., so as to be guided into the gas-liquid separation section 7.

The liquid component that has been subjected to gas-liquid separation in the gas-liquid separation section 7 is taken out as a liquefied nitrogen gas of about −179° C. and about 0.05 MPa.

### With Regard to the Verification Result

In the same manner as in the verification test in the basic structure, a case in which a liquefied nitrogen gas was prepared using the present apparatus was compared with a case in which a liquefied nitrogen gas was prepared using a conventional method, so as to verify the energy efficiency thereof. As will be described below, an improvement of about 25% or more in the energy efficiency could be achieved by using the present apparatus.

(i) A case in which a liquefied nitrogen gas was prepared using a conventional method

LNG was supplied at 1 ton/h, and an energy of 0.28 kWh/Nm³ was needed in preparing a liquefied nitrogen gas of about 0.05 MPa.

(ii) A case in which a liquefied nitrogen gas was prepared using the present method

An energy of 0.21 kWh/Nm³ was sufficient in preparing a liquefied nitrogen gas of about 0.05 MPa under the conditions of the specific example in the above-described present apparatus.

(iii) When the two cases are compared, it has been found out that the electric power could be reduced by about 25%, from the following formula 1.

(0.28−0.21)/0.28=0.25 (formula 1)

### Third Structure Example of the Present Apparatus

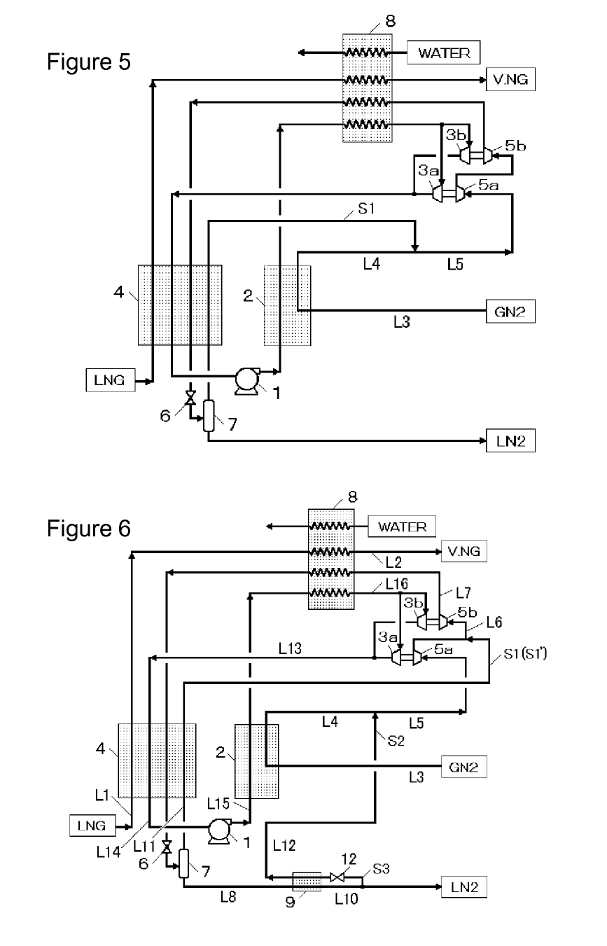

The third structure example of the present apparatus will be schematically shown in FIG. 5. In the same manner as in the second structure example, the present apparatus according to the third structure example has a Rankine cycle system (RC), an adjustment valve 6, and a gas-liquid separation section 7, wherein a third heat exchanger 8 is disposed in a flow passageway through which the heat transfer medium that has been guided out from the first heat exchanger 2 is guided to the turbines 3a, 3b, where the heat transfer medium, the LNG that has been guided out from the second heat exchanger 4, and the liquefied gas that has been guided out from the compressor 5b undergo heat exchange in the third heat exchanger 8. In addition to the functions in the second structure example, the coldness of the LNG can be used further more efficiently, and preparation of a liquefied gas having a high energy efficiency can be carried out.

Here, in the same manner as in the second structure example, a structure in which the liquefied gas can be liquefied by being guided into the first heat exchanger 2 can be applied. Also, without providing the adjustment valve 6 and the gas-liquid separation section 7, the liquefied gas can be guided out from the first heat exchanger 2 and taken out. Here, in the third structure example also, the structure shown by the broken line in FIG. 3 can be applied.

In this manner, in the third heat exchanger 8, the coldness of the LNG can be used further more efficiently by using the residual coldness of the LNG for cooling the heat transfer medium that has been heated in the first heat exchanger 2 and the liquefied gas that has been compressed to have an increased heat quantity. Further, a structure in which cooling water is introduced in the third heat exchanger 8 will be exemplified here.

Heat exchange with cold energy having a large heat capacity can be carried out, and quick transfer of hot heat can be achieved to the heat transfer medium, the liquefied natural gas, and the liquefied gas. Even to transient fluctuation or the like at the time of starting or at the time of stopping, preliminary or auxiliary transfer of hot heat can be achieved to the heat transfer medium, the liquefied natural gas, and the liquefied gas, whereby stable use of the coldness of the LNG and stable energy efficiency can be ensured.

### Fourth Structure Example of the Present Apparatus

The fourth structure example of the present apparatus will be schematically shown in FIG. 6. In addition to the third structure example, the present apparatus according to the fourth structure example is characterized in that a first branching flow passageway S1 (S1′) and a second branching flow passageway S2 are disposed in flow passageways L4 to L6 through which the source material gas is guided from the first heat exchanger 2; a fourth heat exchanger 9 and a third branching flow passageway S3 are disposed in a flow passageway L8 through which the liquid component that has been guided out from the gas-liquid separation section 7 is guided; the apparatus has a flow passageway L11 through which the gas component that has been guided out from the gas-liquid separation section 7 is guided to the first branching flow passageway S1 (S1′) via the second heat exchanger 4, and has a flow passageway L12 through which the liquid component that has been branched by the third branching flow passageway S3 is guided to the second branching flow passageway S2 via the fourth heat exchanger 9, where the liquid component that has been guided out from the gas-liquid separation section 7 is taken out via the fourth heat exchanger 9.

Supply of a liquefied gas being stable and having a good energy efficiency has been enabled by disposing compressors in a plurality of stages as the feeding means for feeding the source material gas constituting the major component and by returning the liquefied gas in a stable condition immediately before being taken out and mixing it with the source material gas.

Here, as described above, a structure can be adopted in which the first branching flow passageway S1 (S1′) is disposed at the position of the flow passageway L4 or L5, and the second branching flow passageway S2 is disposed at the position of the flow passageway L3.

In FIG. 6, further in the fourth structure example, a structure will be exemplified in which a second adjustment valve 12 is disposed in the third branching flow passageway S3, and part of the liquefied gas (herein referred to as LNa) that has been guided out from the fourth heat exchanger 9 is again guided into the fourth heat exchanger 9 via the second adjustment valve 12.

Though having a low pressure, a liquefied gas having a further lower temperature is prepared by adiabatically expanding the low-temperature liquefied gas with the second adjustment valve 12 and can be allowed to function as the coldness in the fourth heat exchanger 9.

Further, in FIG. 6, a structure has been exemplified in which the liquefied gas LNa is directly coupled to the second branching flow passageway S2 via the flow passageway L12.

However, a structure may be adopted in which the liquefied gas LNa is coupled to the second branching flow passageway S2 further via the first heat exchanger 2 or the second heat exchanger 4, whereby the function of the first heat exchanger 2 or the second heat exchanger 4 can be further more effectively used.

### With Regard to the Verification Result

The temperature and the pressure of the gas or liquid in each flow passageway in the case in which liquefied nitrogen gas was prepared using the liquefaction apparatus according to the fourth structure example were verified. The verification results are exemplified in Table 1.

TABLE 1

| | Flow passageway No. | | | | | |
|---|---|---|---|---|---|---|
| | L1 | L2 | L3 | L4 | L5 | L6 |
| Pressure (Bar) | 70.0 | 70.0 | 1.31 | 1.16 | 1.16 | 5.05 |
| Temperature | −150 | −1 | 40 | −91 | −155 | −103 |
| (° C.) | | | | | | |
| | Flow passageway No. | | | | | |
| | L7 | L8 | L10 | L11 | L12 | L13 |
| Pressure (Bar) | 51.67 | 5.10 | 5.00 | 5.10 | 1.16 | 5.50 |
| Temperature | 110 | −179 | −192 | −179 | −180 | −29 |
| (° C.) | | | | | | |

Flow passageway No.

| | L14 | L15 | L16 | S1′ |
|---|---|---|---|---|
| Pressure (Bar) | 5.00 | 25.0 | 24.5 | 5.05 |
| Temperature (° C.) | −134 | −133 | 20 | −150 |

### Fifth Structure Example of the Present Apparatus

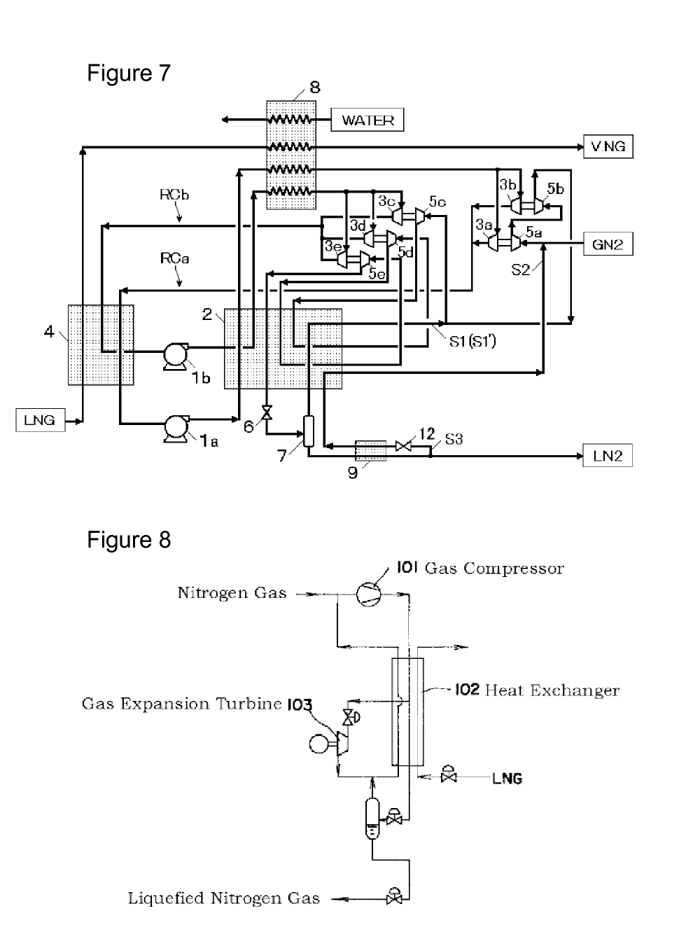

The fifth structure example of the present apparatus will be schematically shown in FIG. 7. In addition to the fourth structure example, the present apparatus according to the fifth structure example is characterized in that the Rankine cycle system is constructed with a plurality of Rankine cycle systems (two RCs in FIG. 7) using a plurality of heat transfer media having different boiling points or heat capacities, and has compressors 5a, 5b that are coupled to a plurality (two is exemplified) of parallelly arranged turbines 3a, 3b in one Rankine cycle system RCa and compressors 5c, 5d, 5e that are coupled to a plurality (three is exemplified) of parallelly arranged turbines 3c, 3d, 3e in another Rankine cycle system RCb.

Here, in the Rankine cycle system RCa, a heat transfer medium having a low boiling point or a small heat capacity is used. In the other Rankine cycle system RCb, a heat transfer medium having a high boiling point or a large heat capacity is used. Supply of a liquefied gas being stable and having a good energy efficiency has been enabled by constructing with a plurality of Rankine cycle systems using a plurality of heat transfer media having different boiling points or heat capacities with respect to the heat transfer media that are involved in transferring the coldness of the LNG and by adjusting the control elements that can be easily controlled, such as the flow rate and the pressure of the heat transfer media in each Rankine cycle system, with respect to the fluctuating elements such as the supply amount and the supply pressure of the liquefied gas.

Furthermore, the source material gas is sequentially compressed by the compressors 5a, 5b that are coupled to the turbines 3a, 3b according to the one Rankine cycle system RCa and thereafter sequentially compressed by the compressors 5c, 5d, 5e that are coupled to the turbines 3c, 3d, 3e according to the other Rankine cycle system RCb.

At this time, the gas compressed by the compressor 5c is guided into the first heat exchanger 2; the gas guided out from the first heat exchanger 2 is compressed by the compressor 5d and guided again into the first heat exchanger 2; and the gas guided out from the first heat exchanger 2 is compressed again by the compressor 5e and guided into the first heat exchanger 2, whereby dynamic power obtained by the plurality of Rankine cycle system s can be effectively used, and constant-pressure cooling can be carried out in a further more efficient compressed state, thereby ensuring a high energy efficiency.

The plurality of heat transfer media having different boiling points or heat capacities as referred to herein include not only a case in which the substances themselves are different and a case in which the substances constituting the mixtures or compounds are different but also a case in which the composition of the mixture of a plurality of substances is different. For example, two RCs having different characteristics can be comprised by forming one heat transfer medium with a mixture of 20% of methane, 40% of ethane, and 40% of propane and forming the other heat transfer medium with a mixture of 2% of methane, 49% of ethane, and 49% of propane. By a combination thereof, transfer of the coldness or the cold energy that matches with various fluctuating elements can be achieved, and efficient transfer of energy to the compression means coupled to the expansion means can be achieved.

Also, when heat transfer media having different components are used, a heat transfer function of a further wider range can be formed. In other words, there is a restriction on the temperature band in which the coldness of the LNG can be used because of the relationship between the temperature of the coldness of the LNG and the boiling point of the source material gas or the temperature of the compressed gas as described above, so that the coldness of the LNG can be used in a plurality of temperature bands by arranging one Rankine cycle system RCa and another Rankine cycle system RCb in series as in the fifth structure example. For example, the cold energy of the LNG can be thermally transferred in a plurality of temperature bands by using a mixture of “methane+ethane+propane” in one Rankine cycle system RCa and using a mixture of “ethane+propane+butane” in another Rankine cycle system RCb. The cold energy of the LNG can be efficiently used by arranging one Rankine cycle system RCa and another Rankine cycle system RCb in series as in the fifth structure example and by using the cold energy of the LNG, for example, in a range of −150 to −100° C. in the one Rankine cycle system RCa and using the cold energy of the LNG, for example, in a range of −150 to −100° C. in the other Rankine cycle system RCb. Further, when this is used as an energy for compressing the nitrogen gas, the energy (consumed electric power) needed per liquefied nitrogen production amount can be greatly reduced.

Here, in FIG. 7, a structure has been exemplified in which the gas component guided out from the gas-liquid separation section 7 is guided via the first heat exchanger 2 to the first branching flow passageway S1 (S1′) disposed in the flow passageway between the compressors 5b-5c.

However, in the same manner as in each of the structure examples described above, a structure can be adopted in which the gas component guided out from the gas-liquid separation section 7 is guided to the first branching flow passageway S1 (S1′) via the second heat exchanger 4 or without intervention of these.

Also, a structure can be adopted in which the first branching flow passageway S1 (S1′) is disposed in the source material supplying flow passageway to the compressor 5a or in any of the flow passageways to the compressors 5a-5e.

Further, a structure can be adopted in which the liquid component branched by the third branching flow passageway S3 is coupled via the fourth heat exchanger 9 directly to the second branching flow passageway S2 disposed in the source material supplying flow passageway to the compressor 5a.

As shown above, each structure example has been described on the basis of each descriptive view; however, the present apparatus is not limited to these but is constructed with a wider concept including a combination of the constituent elements thereof or a combination with other related known constituent elements.

It will be understood that many additional changes in the details, materials, steps and arrangement of parts, which have been herein described in order to explain the nature of the invention, may be made by those skilled in the art within the principle and scope of the invention as expressed in the appended claims. Thus, the present invention is not intended to be limited to the specific embodiments in the examples given above.

1.-7. (canceled)

8. An apparatus for producing a liquefied gas, the apparatus using a Rankine cycle system comprises:
a first compression means for adiabatically compressing a heat transfer medium;
a first heat exchanger for constant pressure heating the adiabatically compressed heat transfer medium;
a plurality of parallelly arranged expansion means for adiabatically expanding the heated heat transfer medium;
a second heat exchanger for constant pressure cooling the adiabatically expanded heat transfer medium; and
a flow passageway for guiding the heat transfer medium that has been guided out from the second heat exchanger to the first compression means,
wherein a plurality of serially arranged second compression means, the number of which is the same as that of the expansion means, that are coupled to the expansion means,
wherein a liquefied natural gas in a low-temperature liquefied state is guided into the second heat exchanger and guided out after heat transfer with the heat transfer medium, and a source material gas that has been fed is sequentially compressed by the plurality of the second compression means and thereafter guided into the first heat exchanger or the second heat exchanger to be cooled by the heat transfer medium, thereby producing a liquefied gas.

9. The apparatus according to claim 1, further comprising:
a flow passageway for guiding the source material gas guided out from the second compression means to the first heat exchanger or the second heat exchanger,
an adjustment valve for adjusting the pressure of the liquefied gas that has been guided out from the first heat exchanger or the second heat exchanger, and
a gas-liquid separation section into which the liquefied gas is guided via the adjustment valve thus being subjected to gas-liquid separation into a liquid component and a gas component,
wherein the gas component that has been guided out from the gas-liquid separation section is guided into the second compression means, and the liquid component is taken out as a liquefied gas.

10. The apparatus according to claim 8, further comprising:
a third heat exchanger disposed in a flow passageway through which the heat transfer medium that has been guided out from the first heat exchanger is guided to the expansion means, and in the third heat exchanger, the heat transfer medium, the liquefied natural gas that has been guided out from the second heat exchanger, and the source material gas that has been guided out from the second compression means undergo heat exchange.

11. The apparatus according to claim 9, wherein
a first branching flow passageway and a second branching flow passageway are disposed in a flow passageway through which the source material gas is guided to the second compression means;
a fourth heat exchanger and a third branching flow passageway are disposed in a flow passageway through which the liquid component that has been guided out from the gas-liquid separation section is guided;
the apparatus has a flow passageway through which the gas component that has been guided out from the gas-liquid separation section is guided to the first branching flow passageway via the first heat exchanger or the second heat exchanger, and has a flow passageway through which the liquid component that has been branched by the third branching flow passageway is guided to the second branching flow passageway via the fourth heat exchanger,
where the liquid component that has been guided out from the gas-liquid separation section is taken out as a liquefied gas via the fourth heat exchanger.

12. The apparatus according to claim 9, wherein
the Rankine cycle system is comprised with a plurality of Rankine cycle systems using a plurality of heat transfer media having different boiling points or heat capacities and has at least a plurality of parallelly arranged first expansion means according to one Rankine cycle system using a heat transfer medium having a low boiling point or a small heat capacity and a plurality of parallelly arranged second expansion means according to another Rankine cycle system using a heat transfer medium having a high boiling point or a large heat capacity; a plurality of serially arranged second compression means,
the number of which is the same as that of the first expansion means, that are coupled to the first expansion means and a plurality of serially arranged third compression means, the number of which is the same as that of the second expansion means, that are coupled to the second expansion means are provided;
wherein the source material gas, after being compressed by the second compression means, is further compressed by the third compression means to be guided into the first heat exchanger, or the source material gas, after being compressed by the second compression means, is further compressed by compression means of an initial stage of the third compression means to be guided into the first heat exchanger, and the liquefied gas that has been guided out is compressed by compression means of a next stage to be guided into the first heat exchanger, and this is repeated for a predetermined number of stages.

13. A method for producing a liquefied gas comprises;
a Rankine cycle system in which a heat transfer medium that has been adiabatically compressed by first compression means is heated in a first heat exchanger at a constant pressure, thereafter adiabatically expanded by a plurality of parallelly arranged expansion means, and further cooled in a second heat exchanger at a constant pressure,
wherein a liquefied natural gas in a low-temperature liquefied state is guided into the second heat exchanger to transfer the coldness thereof to the heat transfer medium, and a source material gas that has been fed is sequentially compressed by a plurality of serially arranged second compression means, the number of which is the same as that of the expansion means, that are coupled to the expansion means, and thereafter guided into the first heat exchanger or the second heat exchanger to be cooled by the heat transfer medium, so as to be taken out as a liquefied gas.

14. The method according to claim 13, wherein
the source material gas guided out from the second compression means is cooled in the first heat exchanger or the second heat exchanger, subjected to pressure adjustment by an adjustment valve, and subjected to gas-liquid separation into a liquid component and a gas component in a gas-liquid separation section, whereafter the gas component guided out from the gas-liquid separation section is guided into the second compression means, and the liquid component is taken out as a liquefied gas.
